(19) United States
(12) Patent Application Publication
(10) Pub. No.: US 2012/0275013 A1
(43) Pub. Date: Nov. 1, 2012

(54) DISPLAY SHEET, METHOD OF MANUFACTURING DISPLAY SHEET, DISPLAY DEVICE AND ELECTRONIC APPARATUS

(75) Inventor: Kenji HAYASHI, Tokyo-To (JP)

(73) Assignee: SEIKO EPSON CORPORATION, Tokyo (JP)

(21) Appl. No.: 13/446,415

(22) Filed: Apr. 13, 2012

(30) Foreign Application Priority Data
Apr. 19, 2011 (JP) 2011-093230
Apr. 19, 2011 (JP) 2011-093231

(51) Int. Cl. G02B 26/02; H01J 9/20

(52) U.S. Cl. 359/296; 445/25

(57) ABSTRACT

A display sheet includes a substrate provided at a display surface side; a facing substrate arranged to face the first substrate; a display layer provided between the substrate and the facing substrate; a plurality of first partition units provided in the display layer and dividing the display layer into a plurality of regions in the X direction and extending in the Y direction intersecting the X direction; a porous layer provided inside each of the regions; and a dispersion liquid filled inside each of the regions in which first and second particles are dispersed with a dispersion medium.

### TECHNICAL FIELD

The present invention relates to a display sheet, a method of manufacturing a display sheet, a display device and an electronic apparatus.

### BACKGROUND ART

For example, as the configuration of an image display unit of electronic paper, an electrophoretic display using the electrophoresis of particles is known (for example, refer to Patent Document 1). Electrophoretic displays have superior portability and energy efficiency and are particularly suitable as image display units of electronic paper.

An electrophoretic display has a pair of electrodes arranged to face each other and a display layer provided therebetween, and, in the display layer, for example, there is filled a dispersion liquid in which positively charged white particles and negatively charged black particles are dispersed in a liquid phase dispersion medium. Such an electrophoretic display is configured such that a desired image is displayed by applying a voltage between the pair of electrodes and causing the white particles and the black particles to migrate in a desired direction.

Here, as the configuration of the display layer, there is known a “partition wall type” in which the display layer is divided into a plurality of cells by partition walls as in Patent Document 1 and a dispersion liquid is filled in each cell. However, in the “partition wall type” display device, the aperture ratio (ratio occupied by the effective display region) of the display surface is reduced by the partition walls and there is a problem in that the display characteristics are deteriorated. In addition to this, the dispersion liquid must be filled inside each cell, and the processing is problematic. In particular, when it is necessary to fill different dispersion liquids (dispersion liquids in which the colors of the particles are different) in a plurality of adjacent cells in order to achieve a full-color display, the processing becomes even more problematic. In such a case, there may be times when a dispersion liquid to be filled in one cell is mixed into a neighboring cell, resulting in worsening of the display characteristics.

### CITATION LIST

[Patent Document]
[Patent Document 1] JP-A-2010-44114

### SUMMARY OF INVENTION

### Technical Problem

The object of the present invention is to provide a display sheet capable of reducing the deterioration of the display characteristics and being easily manufactured and capable of exhibiting excellent display characteristics, a method of manufacturing a display sheet, a display device, and a highly reliable electronic apparatus.

### Means for Solving the Problem

The object is achieved by the present invention described below.

A display sheet of the present invention includes a first substrate provided at a display surface side,

a second substrate arranged to face the first substrate, and

a display layer provided between the first substrate and the second substrate,

in which the display layer includes,

in a plan view of the display layer, a plurality of first partition units dividing the display layer into a plurality of regions in a first direction and extending in a second direction intersecting the first direction,

a porous layer provided inside each of the plurality of regions, and

a dispersion liquid filled inside each of the plurality of regions in which at least one type of positively or negatively charged first particle is dispersed with a dispersion medium.

In this manner, it is possible to provide a display sheet capable of reducing the deterioration of the display characteristics and being easily manufactured and capable of exhibiting excellent display characteristics.

It is preferable that the display layer include a plurality of pixels which are set in plural along the first direction and set in plural along the second direction, and

each of the plurality of regions is formed so as to separate adjacent pixels in the first direction and include adjacent pixels in the second direction.

In this manner, it is possible to exhibit superior display characteristics.

It is preferable that the porous layer regulate movement using precipitation and diffusion of the first particles.

In this manner, bias of the first particles is effectively suppressed and it is possible to exhibit superior display characteristics.

In the display sheet of the present invention, it is preferable that the porous layer be an aggregation of fibers or an aggregation of particles.

In this manner, the configuration of the porous layer becomes simple.

In the display sheet of the present invention, it is preferable that each of the plurality of regions have a length in the first direction which is constant along the second direction.

In this manner, the configuration of the first partition units becomes simple.

In the display sheet of the present invention, it is preferable that, in each of the plurality of regions, there be a plurality of second partition units which are provided spaced at intervals in the second direction, protrude from the second substrate side, and are spaced apart from the first substrate in the thickness direction of the display layer.

In this manner, it is possible to more effectively prevent the movement of the first particles in the second direction without reducing the effective display region. In addition, the second partition units are position determining members and it is possible to manufacture the display device with higher precision.

In the display sheet of the present invention, it is preferable that each of the plurality of regions have a plurality of broad regions provided spaced at intervals in the second direction, and a plurality of narrow regions provided between the adjacent broad regions in the second direction and of which the length of the first direction is shorter than that of the broad regions.

In this manner, it is possible to more effectively prevent the movement of the first particles in the second direction.

In the display sheet of the present invention, it is preferable that there be a plurality of second partition units which are provided inside each of the plurality of narrow regions, protrude from the second substrate side, and are spaced apart from the first substrate in the thickness direction of the display layer.

In this manner, it is possible to more effectively prevent the movement of the first particles in the second direction without reducing the effective display region. In addition, the second partition units are position determining members and it is possible to manufacture the display device with higher precision.

In the display sheet of the present invention, it is preferable that, in each of the plurality of second partition units, the length of the first direction gradually decrease toward the first substrate from the second substrate side.

In this manner, it is possible to more easily manufacture a high-precision display device.

In the display sheet of the present invention, it is preferable that the porous layer be positioned between the respective tips of the plurality of second partition units and the first substrate.

In this manner, it is possible to more effectively prevent the movement of the first particles in the second direction.

In the display sheet of the present invention, it is preferable that the first particles included in the dispersion liquid filled inside the adjacent regions have mutually different colors.

In this manner, the display sheet is capable of color display.

In the display sheet of the present invention, it is preferable that there be further included a first region, a second region, and a third region which are arranged to be lined up in the first direction in the plurality of regions,

in which, among the first particles included in the dispersion liquid filled inside the first region and the first particles included in the dispersion liquid filled inside the second region, the color of one is magenta and the color of the other is cyan, and

the color of the first particles included in the dispersion liquid filled inside the third region is yellow.

In this manner, the display sheet has an excellent color display characteristic.

In the display sheet of the present invention, it is preferable that the plurality of regions further include a fourth region arranged next to the third region and that the color of the first particles included in the dispersion liquid filled inside the fourth region be black.

In this manner, it is possible to display black with a lower reflectivity and the display contrast is improved.

In the display sheet of the present invention, it is preferable that the dispersion liquid further include second white particles charged with the opposite polarity to the first particles.

In this manner, the display sheet is capable of full color display.

The display sheet of the present invention includes a first substrate provided at a display surface side,

a second substrate arranged to face the first substrate, and

a display layer provided between the first substrate and the second substrate,

in which the display layer includes,

in a plan view of the display layer, a plurality of first partition units dividing the display layer into a plurality of regions in a first direction and extending in a second direction intersecting the first direction,

a plurality of second partition units which are arranged inside each of the plurality of regions to be spaced at intervals in the second direction, protrude from the second substrate side, and are spaced apart from the first substrate in the thickness direction of the display layer, and

a dispersion liquid in which at least one type of positively or negatively charged first particle is dispersed with a dispersion medium filled inside each of the plurality of regions.

In this manner, it is possible to provide a display sheet capable of being easily manufactured while reducing the deterioration of the display characteristics and capable of exhibiting excellent display characteristics.

A method of manufacturing the display sheet includes: forming a plurality of first partition units spaced at intervals in a first direction on one surface of a first substrate and extending in a second direction intersecting the first direction, and forming a plurality of divided regions using an adjacent pair of the first partition units;

providing a porous layer inside each of the plurality of regions;

filling a dispersion liquid in which at least one type of positively or negatively charged first particle is dispersed with a dispersion medium inside each of the plurality of regions and holding the dispersion liquid in the porous layer; and

bonding the first substrate of the first partition units and the second substrate on the opposite side, and forming a display layer between the first substrate and the second substrate.

In this manner, it is possible to manufacture a display device having desired display characteristics easily and with high precision.

The display device of the present invention is provided with the display sheet of the present invention.

In this manner, it is possible to obtain a display device having excellent reliability.

The electronic apparatus of the present invention is provided with the display device of the present invention.

In this manner, it is possible to obtain an electronic apparatus having excellent reliability.

### BRIEF DESCRIPTION OF DRAWINGS

FIG. 1 is a cross-sectional view showing a display device according to a first embodiment of the present invention.

FIG. 2 is a plan view (upper surface view) of the display device shown in FIG. 1.

FIG. 3 is a cross-sectional view describing the driving of the display device shown in FIG. 1.

FIG. 4 is a cross-sectional view describing the method of manufacturing the display device shown in FIG. 1.

FIG. 5 is a cross-sectional view showing a display device according to a second embodiment of the present invention.

FIG. 6 is a plan view (upper surface view) of the display device shown in FIG. 5.

FIG. 7 is a cross-sectional view describing the driving of the display device shown in FIG. 5.

FIG. 8 is a cross-sectional view describing the method of manufacturing the display device shown in FIG. 5.

FIG. 9 is a plan view (upper surface view) showing a display device according to a third embodiment of the present invention.

FIG. 10 is a plan view (upper surface view) showing a display device according to a fourth embodiment of the present invention.

FIG. 11 is a plan view (upper surface view) showing a display device according to a fifth embodiment of the present invention.

FIG. 12 is a schematic perspective view showing a display device according to a sixth embodiment of the present invention.

FIG. 13 is a cross-sectional view of the display sheet shown in FIG. 12.

FIG. 14 is a perspective view showing a case where the electronic apparatus according to an embodiment of the present invention is applied to electronic paper.

FIG. 15 is a diagram showing a case where the electronic apparatus according to an embodiment of the present invention is applied to a display.

### DESCRIPTION OF EMBODIMENTS

Below, a detailed description will be given of the display sheet, the method of manufacturing the display sheet, the display device and the electronic apparatus of the present invention based on preferred embodiments shown in the attached drawings.

### 1. Display Device

First, a description will be given of the display device incorporating the display sheet of the present invention.

### First Embodiment

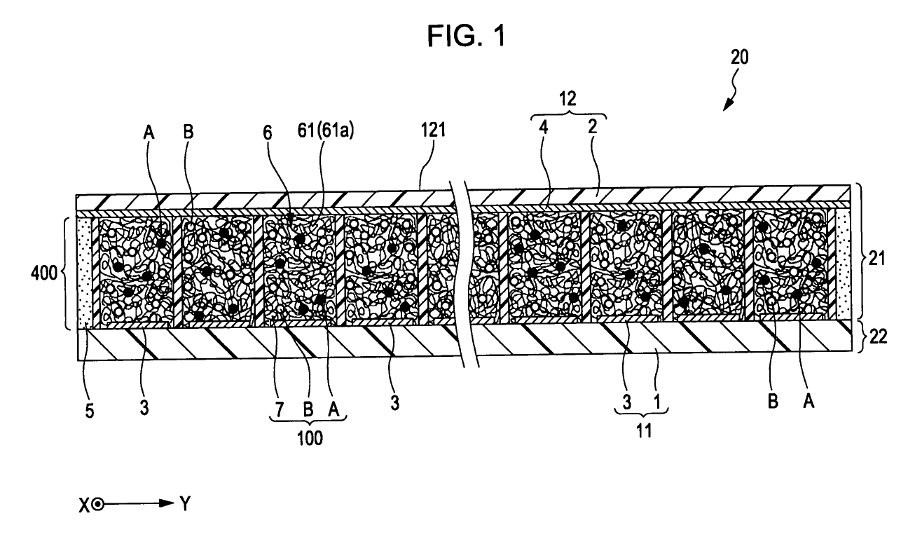

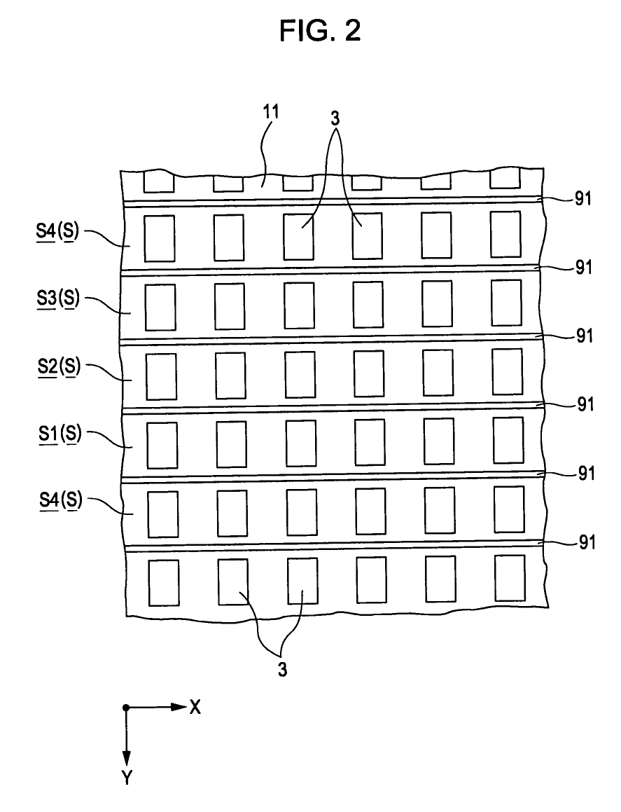

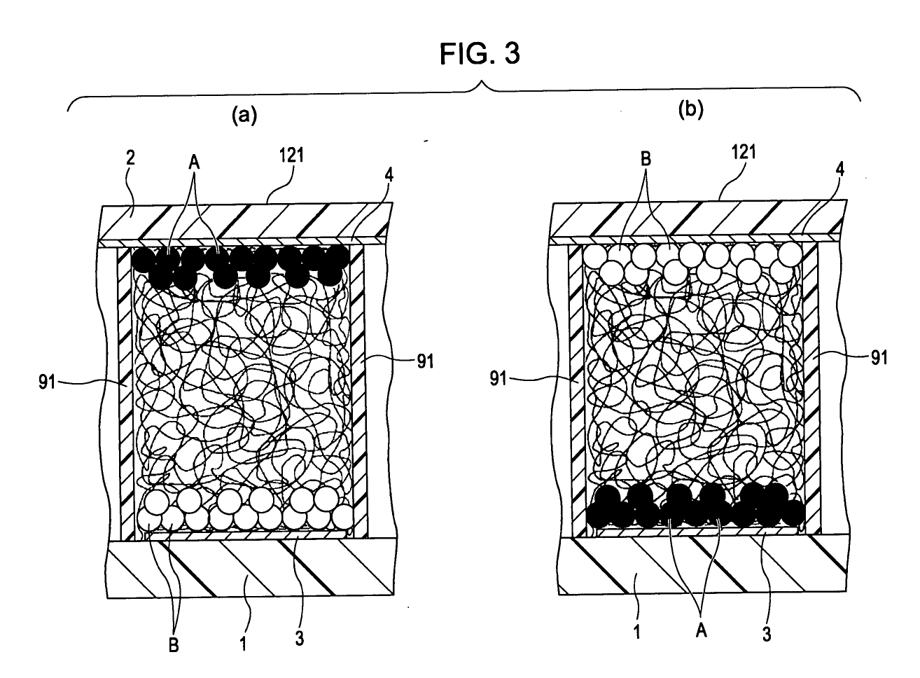

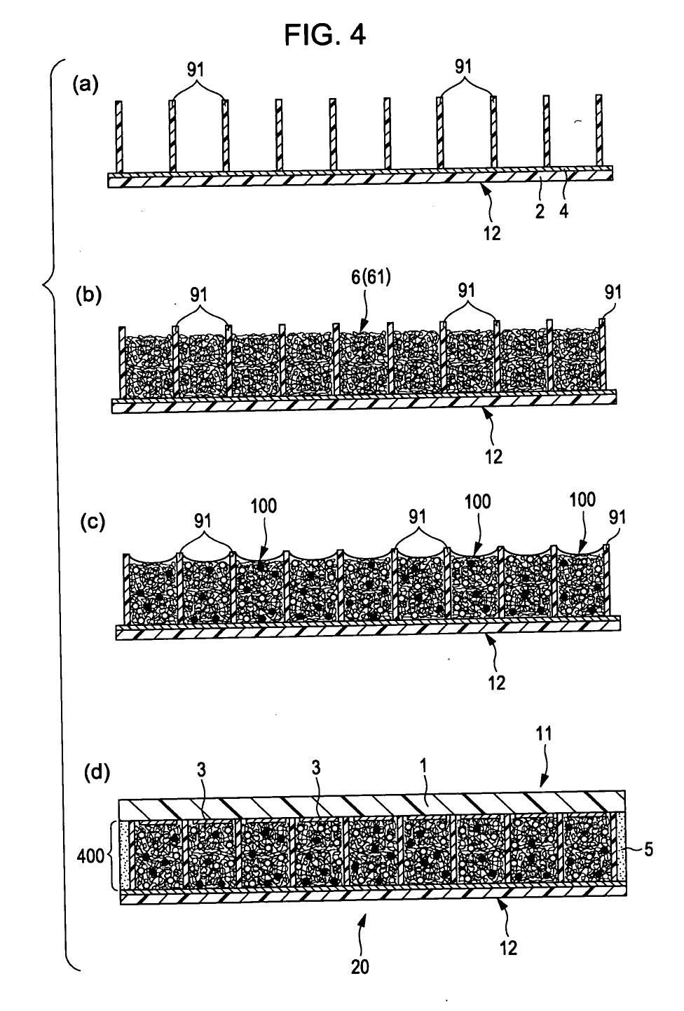

FIG. 1 is a cross-sectional view showing the display device according to a first embodiment of the present invention, FIG. 2 is a plan view (upper surface view) of the display device shown in FIG. 1, FIG. 3 is a cross-sectional view describing the driving of the display device shown in FIG. 1, and FIG. 4 is a cross-sectional view describing the method of manufacturing the display device shown in FIG. 1. Here, in the following, for ease of description, a description will be given with the upper side in FIG. 1 and FIG. 4 as “up” and the lower side as “down”. In addition, as shown in FIG. 1, the two mutually intersecting directions in the plan view of the display device are set as the “X direction” and the “Y direction”. The same is true for the other figures. In addition, in FIG. 2, for convenience of description, illustration of the substrate 12 and the porous layer 6 is omitted.

The display device (display device of the present invention) 20 shown in FIG. 1 is an electrophoretic display device displaying a desired image using the migration of particles. The display device 20 includes a display sheet (front plane) 21, and a circuit substrate (back plane) 22.

As shown in FIG. 1, the display sheet 21 includes a substrate (first substrate) 12 provided with a flat plate-shaped base 2, and a second electrode 4 provided at the lower surface of the base 2, and a display layer 400 provided on the substrate 12 and in which a dispersion liquid 100 is filled. In the display sheet 21, the upper surface of the substrate 12 configures the display surface 121.

On the other hand, the circuit substrate 22 includes a facing substrate (second substrate) 11 provided with a flat plate-shaped base 1, and a plurality of first electrodes 3 provided at the upper surface of the base 1, and a circuit (not shown) provided on the facing substrate 11.

For example, the circuit includes a TFT (switching element) arranged in a matrix, a gate line and a data line formed corresponding to the TFT, a gate driver applying a desired voltage to the gate line, a data driver applying a desired voltage to the data line, and a control unit controlling the driving of the gate driver and the data driver.

In the display device 20, the facing substrate 11 doubles as a second substrate of the display sheet 21.

Below, sequential descriptions will be given of the configuration of each part.

The base 1 and the base 2 are respectively configured by sheet-shaped (flat plate-shaped) members, and each member arranged therebetween has a supporting and protecting function. Each of the bases 1 and 2 may be either flexible or hard; however, flexible is preferable. By using flexible bases 1 and 2, it is possible to obtain a flexible display device 20, that is, a display device 20 useful in the construction of electronic paper, for example.

When the bases 1 and 2 are set to have flexibility, glass or resin having high transparency may be exemplified as the configuration materials thereof. As the resin, respectively, for example, polyesters such as PET (polyethylene terephthalate) and PEN (polyethylene naphthalate), polyolefins such as polyethylene, modified polyolefin, polyamide, thermoplastic polyimide, polyether, polyether ether ketone, polyurethanes, various types of thermoplastic elastomer or the like such as chlorinated polyethylenes, or copolymers mainly composed of these, blends, and polymer alloys or the like may be exemplified, and it is possible to use a mix of one kind or two kinds or more among these.

The respective average thicknesses of the bases 1 and 2 are appropriately set according to the configuration materials, the applications, and the like and are not particularly limited; however, when the bases have flexibility, approximately 20 μm or more to 500 μm or less is preferable and approximately 25 μm or more to 250 μm or less is more preferable. Thus, it is possible to achieve miniaturization (in particular, thinning) of the display device 20 while achieving harmony between the flexibility and strength of the display device 20.

A film-shaped first electrode 3 and a second electrode 4 are respectively provided on the surfaces of the display layer 400 of the bases 1 and 2, that is, on the upper surface of the base 1 and the lower surface of the base 2. In this embodiment, the second electrode 4 is a common electrode, and the first electrode 3 is an individual electrode (pixel electrode connected to the TFT) divided into a matrix shape (line shape) in the X direction and the Y direction. In the display device 20, a region where one of the first electrodes 3 and the second electrode 4 overlap configures one pixel.

The respective configuration materials of the electrodes 3 and 4 are not particularly limited as long as the materials substantially have conductivity, for example, a metal material such as gold, silver, copper, or aluminum, or an alloy or the like containing these, carbon-based materials such as carbon black, graphene, carbon nanotubes, or fullerenes, electrically conductive polymer material such as polyacetylene, polyfluorene, and polythiophene or derivatives thereof, ion conductive polymer material in which ionic substances such as NaCl, Cu (CF₃SO₃)₂, or the like are dispersed in a matrix resin of polyvinyl alcohol, polycarbonate, or the like, and various types of conductive material such as conductive oxide material of indium oxide (IO), indium tin oxide (ITO), fluorine-doped tin oxide (FTO), zinc oxide, or the like may be exemplified, and it is possible to use a combination of one kind or two kinds or more among these.

Further, the respective average thicknesses of the electrodes 3 and 4 are appropriately set according to the configuration materials, the applications, and the like and are not particularly limited; however, approximately 0.01 μm or more to 10 μm or less is preferable and approximately 0.02 μm or more to 5 μm or less is more preferable.

Here, among each of the bases 1 and 2 and each of the electrodes 3 and 4, the base and electrode arranged at the display surface 121 side respectively have visible light transparency, that is, are set to be substantially transparent (colorless and transparent, colored and transparent, or translucent). In the embodiment, since the upper surface of the substrate 12 configures the display surface 121, at least the base 2 and the second electrode 4 are set to be substantially transparent. In this manner, it is possible to easily recognize the image displayed on the display device 20 by visual inspection from the side of the display surface 121.

Between the substrate 12 and the facing substrate 11, the sealing portion 5 is provided along the edges thereof. The display layer 400 is airtightly sealed by the sealing portion 5. In this manner, it is possible to prevent the permeation of moisture into the display device 20, and to more reliably prevent the deterioration of the display performance of the display device 20.

The configuration material of the sealing portion 5 is not particularly limited, for example, various types of resin materials such as acrylic resins, urethane resins, thermoplastic resins such as olefin resins, epoxy resins, melamine resins, thermosetting resin such as phenolic resins may be exemplified, and it is possible to use a combination of one kind or two kinds or more among these.

As shown in FIGS. 1 and 2, the display layer 400 includes a plurality of first partition units 91, a porous layer 6 provided inside each region S divided by the plurality of first partition units 91, and a dispersion liquid 100 filled inside each region S.

Inside the display layer 400, a plurality of first partition units 91 extending in the X direction are provided. In addition, the plurality of first partition units 91 are disposed in parallel spaced apart at equal intervals in the Y direction. According to the plurality of first partition units 91, the display layer 400 is divided in a liquid-sealed manner (so that movement of liquid from a predetermined region S to a neighboring region S is prevented) into a plurality of regions S lined up in the Y direction. In addition, each region S is formed so as to include a row of a plurality of first electrodes 3 (pixels) lined up in the X direction. In other words, each region S is formed so as to separate adjacent pixels in the Y direction and to share adjacent pixels in the X direction. By configuring the plurality of first partition units 91 in this manner, the aperture ratio of the display surface 121 is improved and it is possible to exhibit superior display characteristics.

In addition, each region S is formed so that the length (width) of the Y direction is constant along the X direction. In this manner, since each region S has a simple shape, it is possible to simplify the manufacturing of the display device 20. The width of each region S (the separation distance between adjacent first partition units 91) is not particularly limited; however, approximately 30 μm or more to 60 μm or less is preferable. In this manner, it is possible to fill a sufficient amount of the dispersion liquid 100 in each region S and to make the pixels smaller. Therefore, according to the display device 20, it is possible to display a fine and clear image using the display surface 121.

Each first partition unit 91 forms a straight line. In this manner, since not only does the configuration of the first partition units 91 become simple, but it is possible to continuously coat the dispersion liquid 100 having similar particles or a plurality of particles in a stripe shape using an ink jet method or various types of printing methods, it is possible to obtain an improvement in productivity. In addition, the width of each of the first partition units 91 (the length in the Y direction) is not particularly limited; however, approximately 1 μm or more to 5 μm or less is preferable. In this manner, it is possible to widen the aperture ratio of the display surface 121 while maintaining the mechanical strength of the first partition units 91. Therefore, it is possible to exhibit superior display characteristics and reliability.

In addition, it is preferable that the surfaces of the first partition units 91 be subjected to various water-repellent processes such as fluorocarbon plasma processing. In this manner, as described later, the manufacturing of the display device 20 becomes simpler, and it is possible to obtain a display device 20 capable of exhibiting superior display characteristic and reliability.

The configuration material of the first partition units 91 is not particularly limited, for example, epoxy resins, phenol resins, urea resins, melamine resins, polyesters (unsaturated polyesters), polyimides, silicone resin, various kinds of thermoplastic resin or thermosetting resin such as urethane or the like may be exemplified, and it is possible to use a mix of one kind or two kinds or more among these.

Here, in this embodiment, the cross-sectional surface shape of each first partition unit 91 is rectangular (oblong); however, it is not limited thereto, for example, the width may have a tapered shape gradually reduced from the substrate 12 toward the facing substrate 11 side. The taper angle θ1 of this case (the angle made by the side surface of the first partition units 91 and the upper surface of the facing substrate 11 as shown in FIG. 1 in the plan view seen from the X direction) is not particularly limited; however, an angle of approximately 70° or more to 90° or less is preferable. In this manner, it is possible to prevent that the width of the substrate 12 of the first partition units 91 becomes excessively wide, or that the width of the facing substrate 11 opposite thereto becomes excessively narrow.

Above, a description has been given of the first partition units 91.

As shown in FIG. 1 and FIG. 2, inside each region S of the display layer 400, a porous layer 6 is provided. The porous layer 6 has an effect of raising the permeability of the dispersion liquid 100, and improving the pattern coatability of the dispersion liquid 100 formed between the first partition units 91. In addition, the porous layer 6 has a function of regulating (suppressing) the movement according to the precipitation according to the weight of the particles A and B and the diffusion in the dispersion medium and performing holding in the vicinity of the surface of the electrode 3 or the electrode 4, by holding the first particles A and the second particles B in the dispersion liquid 100 in the interior or the surface thereof. On the other hand, in the porous layer 6, when an electric field acts between the electrodes 3 and 4, it is possible for the first and second particles A and B to move between the electrodes according to the electric field. In addition, to further increase the migration speed of the first and second particles A and B, a structure may be adopted in which the porous layer 6 is only formed in the vicinity of the surface of the second electrode 4 where visible, and the holding is only applied to the particles on the visible side.

Therefore, the thickness of the porous layer 6 is preferably made equal to or thinner than the thickness of each region S (display layer 400). In this manner, since it is possible to provide the porous layer 6 in the portions for which it is necessary to obtain holding of the particles, it is possible to more effectively regulate the precipitation and the diffusion in the dispersion medium according to the weight of the first and second particles A and B described above.

The porous layer 6 is configured by an aggregation of fibers. In this manner, a porous layer 6 which is excellent in the above function and which has a comparatively simple configuration is obtained. By using fibers 61a alone or mixing a small amount of binder resin with the fibers 61a, the porous layer 6 is configured by a non-woven body 61 formed without being interwoven. Since the fiber diameter and the inter-fiber distance of the non-woven body 61 may be set independently, it is possible to easily form a porous layer 6 capable of exhibiting the desired functions by configuring the porous layer 6 using the non-woven body 61.

As the configuration material of the fiber 61a, for example, urethane resin, urea resin, ester resin, ether resin, olefin resins of polyethylene and polypropylene or the like, acrylic resin, various types of thermoplastic material such as various types of thermoplastic elastomer of ethylene copolymers such as ethylene-vinyl acetate copolymer, ethylene methacrylic acid methyl copolymer, and ethylene cyclic olefin copolymer, may be exemplified. In addition, as the binder resin, since it is necessary to have a function of bonding the fibers, it is possible to use adhesive resin such as urethane resin, epoxy resin, acrylic resin, or polybutadiene elastomers.

The length of the fiber 61a is not particularly limited; however, approximately 1 μm or more to 5000 μm or less is preferable. In this manner, since it becomes easier to provide the non-woven body 61 in the first partition units 91 by pattern coating the fiber 61a or the like, the manufacturing becomes simple.

In addition, the diameter of the fiber 61a is preferably fine from the viewpoint of various performances such as display characteristics and responsiveness, specifically, approximately 0.1 μm or more to 10 μm or less is preferable and approximately 0.5 μm or more to 5 μm or less is more preferable. In addition, the cross-sectional shape of the fiber 61a is not particularly limited; however, a circular shape is preferable. In this manner, it is possible to smoothly perform the movement of the first and second particles A and B in the dispersion liquid 100.

The average pore diameter of the non-woven body 61 is not particularly limited as long as it is a size in which it is possible for the first and second particles A and B to move in the non-woven body 61 when an electric field is applied; however, specifically, approximately 10 times or more to 10000 times or less of the average particle diameter of the first particles A (second particles B) is preferable and approximately 20 times or more to 1000 times or less is more preferable. In this manner, it is possible to more effectively regulate the movement according to the weight of the first and second particles A and B. In addition, since it is possible to make the use amount of the fiber 61a used for forming the porous layer 6 comparatively small, when seen from the display surface 121, light transmittance loss due to the porous layer 6 is reduced and the visibility of the electrophoretic particles is improved.

The porosity (porosity in a state of being arranged in the display layer 400) of the porous layer 6 is preferably approximately 50% or more to 99% or less and preferably approximately 75% or more to 85% or less. In this manner, in the porous layer 6, the first and second particles A and B migrate smoothly during the voltage application. Further, it is possible to effectively regulate the movement according to the weight of the first and second particles A and B. In addition, since it is possible to make the use amount of the fiber 61a used for forming the porous layer 6 comparatively small, the porous layer 6 does not stand out when seen from the display surface 121.

The modulus of elasticity of the fiber 61a is not particularly limited; however, approximately 0.01 Mpa or more to 1000 MPa or less is preferable. In this manner, the porous layer 6 is appropriately deformed and, in particular, is useful in the case of a flexible display device 20.

The porous layer 6 is preferably colored white. In this manner, in the white display state to be described later, it is possible to display a crisp white with higher reflectivity due to the synergistic effect of the second particles B. In addition, it is also preferable that the porous layer 6 be substantially colorless and transparent and have a different refractive index to the dispersion liquid 100. In this manner, since the light is diffused and reflected by the porous layer 6, similarly to the case of being colored white, it is possible to display a crisp white with higher reflectivity due to the synergistic effect of the second particles B in the white display state.

Above, a description has been given of the porous layer 6.

Here, the porous layer 6 is not limited to being configured by the non-woven body 61 of the embodiment and, for example, may be configured of an aggregation of fine particles. As the configuration material of the fine particles in this case, it is possible to use the same material as the fiber 61a described above. Further, the average particle diameter of the fine particles is not particularly limited; however, approximately 0.1 μm or more to 10 μm or less is preferable. In this manner, it is possible to prevent the porous layer 6 from becoming excessively rough and it is possible to more effectively regulate the movement according to the weight of the first and second particles A and B.

Next, the dispersion liquid 100 will be described.

In the display device 20, as described above, the display layer 400 is divided into a plurality of regions S lined up in the Y direction.

As shown in FIG. 2, the plurality of regions S includes a first region S1, a second region S2, a third region S3, and a fourth region S4, and these are arranged side by side so as to repeat in the Y direction in this order. Then, each of the regions S1 to S4 is filled with the dispersion liquid 100.

The dispersion liquid 100 is formed by dispersing first particles A, which are negatively charged, and second particles B, which are positively charged and have a different color than the first particles A, in a dispersion medium 7, and the colors of the first particles A are different for each of the regions S1 to S4. In other words, first particles A having different colors are dispersed in the dispersion liquid 100 filled in the adjacent regions S. Here, the second particles B and the dispersion medium 7 have the same configuration in each of the regions S1 to S4.

The color of the first particles A included in the dispersion liquid 100 filled in the first region S1 is cyan, the color of the first particles A included in the dispersion liquid 100 filled in the second region S2 is magenta, the color of the first particles A included in the dispersion liquid 100 filled in the third region S3 is yellow, and the color of the first particles A included in the dispersion liquid 100 filled in the fourth region S4 is black. Further, the color of the second particles B is white in all of the regions S1 to S4. By setting the colors of the first and second particles A and B in this manner, full-color display becomes possible and it is possible to exhibit superior display characteristics having high white reflectivity close to paper.

As the respective first and second particles A and B, it is possible to use any material as long as it holds an electric charge, for example, oxide particles such as titanium oxide, zinc oxide, iron oxide, chromium oxide, and zirconium oxide, nitride particles such as silicon nitride, titanium nitride, sulfide particles such as zinc sulfide, boride particles such as titanium boride, inorganic pigment particles such as strontium chromate, cobalt aluminate, copper chromite, and ultramarine, and organic pigment particles such as azo, quinacridone, anthraquinone, dioxazine, and perylene, or the like may be used. In addition, it is also possible to use composite particles in which a pigment is coated on the surface of resin particles configured by acrylic resin, urethane resin, urea resin, epoxy resin, polystyrene, polyester, or the like.

In addition, the respective average particle diameters of the first and second particles A and B are not particularly limited; however, approximately 10 nm or more to 500 nm or less is preferable and approximately 20 nm or more to 300 nm or less is more preferable. When the average particle diameter is less than 10 nm, sufficient chromaticity may not be obtained, whereby the display contrast deteriorates and the display may become blurred. Conversely, when the average particle diameter exceeds 300 nm, there is a need to increase the degree of coloring of the particles themselves more than necessary, whereby the use amount of the pigment or the like is increased, it becomes difficult to quickly move the particles in the portion to which the voltage for display is applied, and there may be a deterioration in the response speed.

In addition, the average particle diameters of the first and second particles A and B are preferably approximately the same as each other. In this manner, since it is possible to move the first and second particles A and B together in the porous layer 6 and hold them in the porous layer 6, it is possible to exhibit superior display characteristics.

Here, the average particle diameter of the first and second particles A and B means the volume average particle diameter measured by a dynamic light diffusion type particle size distribution measurement device (for example, product name: LB-500, manufactured by Horiba, Ltd.).

As the dispersion medium 7, one having a boiling point of 100° C. or more and a comparatively high insulating property is preferably used. As the dispersion medium 7, for example, various types of water (for example, distilled water, pure water, and the like), alcohols such as butanol and glycerin, cellosolves such as butyl cellosolve, esters such as butyl acetate, ketones such as dibutyl ketones, aliphatic hydrocarbons such as pentane (liquid paraffin), alicyclic hydrocarbons such as cyclohexane, aromatic hydrocarbons such as xylene, halogenated hydrocarbons such as methylene chloride, heterocyclic class of halogenated aromatic, aromatic complex ring types such as pyridine, nitriles such as acetonitrile, amides such as N,N-dimethyl formamide, carboxylic acid salt, silicon oil, or various other types of oils, may be exemplified, and these may be used alone or as a mixture.

Among these, as the dispersion medium 7, one having aliphatic hydrocarbons (liquid paraffin), or silicon oil as a main component is preferable. The dispersion medium 7 having liquid paraffin or silicon oil as a main component is preferable due to the high aggregation suppression effect on the first and second particles A and B. In this manner, it is possible to more substantially prevent or suppress the deterioration over time of the display performance of the display device 20. In addition, the liquid paraffin or silicon oil is preferable from the viewpoint that the weather resistance is excellent because it does not have unsaturated bonds and that safety is also high.

Above, a description has been given of the configuration of the display device 20.

In the display device 20, as a result of using the first partition units 91 extending in the X direction, it is possible to increase the aperture ratio of the display surface 121 and to exhibit a high display contrast.

In addition, in the display device 20, since it is possible to regulate the movement in the X direction of the first and second particles A and B (movement due to their own weight) by the function of the porous layer 6 inside each region S, it is possible to suppress biasing of the first and second particles A and B in the display layer 400 and to maintain a state where the first and second particles A and B are uniformly dispersed in the display layer 400 in the plan view of the display layer 400. Therefore, it is possible to preserve approximately the same display characteristics (especially the reflectivity of the display color) in the entire area of the display layer 400 and to display crisp images with no unevenness over long periods on the display surface 121.

Specifically, for example, when the display device 20 is made to stand as a book, for instance, when the display surface 121 has a posture so as to be approximately parallel to the vertical direction, the first and second particles A and B are moved to the lower side of the vertical direction by their own weight. However, the movement due to their own weight is regulated by the porous layer 6. Therefore, in the display device 20, it is possible to maintain a state where the first and second particles A and B are uniformly dispersed in each region S, and to display crisp images with no unevenness over long periods on the display surface 121.

The display device 20 is driven in the following manner, for example.

Here, below, a description will be given of a case where a voltage is applied to one predetermined third electrode.

—Color Display State of the First Particles—

When a voltage is applied between the first electrode 3 and the second electrode 4 so that the first electrode 3 has a negative potential and the second electrode 4 has a positive potential, the electric field generated by the application of the voltage acts on the first and second particles A and B in the display layer 400. Then, the first particles A migrate to the side of the second electrode 4 and are gathered at the second electrode 4, and the second particles B migrate to the side of the first electrode 3 and are gathered at the first electrode 3. In this manner, as shown in FIG. 3(a), the color of the first particles A (that is, any one of cyan, magenta, yellow, and black) is displayed on the display surface 121.

—Color Display State of the Second Particles—

When a voltage is applied between the first electrode 3 and the second electrode 4 so that the first electrode 3 has a positive potential and the second electrode 4 has a negative potential, the electric field generated by the application of the voltage acts on the first and second particles A and B in the display layer 400. Then, the first particles A migrate to the side of the first electrode 3 and are gathered at the first electrode 3, and the second particles B migrate to the side of the second electrode 4 and are gathered at the second electrode 4. In this manner, as shown in FIG. 3(b), the color of the second particles B (that is, white) is displayed on the display surface 121.

In the display device 20, as shown in FIG. 2, one large pixel (pixel unit for displaying one display color) is formed by 4 pixels lined up in the Y direction. By selecting the above-described display color for each of the regions S1 to S4 included in one large pixel, it is possible to display the desired color in the pixel.

Specifically, when performing a black display, the first region S1, the second region S2, the third region S3, and the fourth region S4 are set to a cyan display, a magenta display, a yellow display and a black display. In addition, when performing a white display, the first region S1, the second region S2, the third region S3, and the fourth region S4 are all set to a white display. In addition, when performing a cyan display, the first region S1 is set to a cyan display, and the other regions S2 to S4 are set to a white display. In addition, when performing a magenta display, the second region S2 is set to a magenta display, and the other regions S1, S2 and S3 are set to a white display. In addition, when performing a yellow display, the third region S3 is set to a yellow display, and the other regions S1, S2 and S4 are set to a white display.

In particular, as in the display device 20, by positioning the third region S3 in which yellow first particles A exist next to the fourth region S4 in which black first particles A exist, it is possible to further lower the reflectivity during black display. Therefore, it is possible to exhibit a high display contrast.

By performing this selection of display colors for each pixel, it is possible to display the desired image on the display surface 121.

Next, the method of manufacturing the display device 20 will be described.

The method of manufacturing the display device 20 includes: forming a plurality of first partition units 91 spaced at intervals in the Y direction on one surface of the substrate 12 and extending in the X direction, and forming a plurality of divided regions S using adjacent pairs of the first partition units 91; providing a porous layer 6 inside each region S; filling a dispersion liquid 100 inside each region S; and bonding the substrate 12 of the first partition units 91 and the facing substrate 11 on the opposite side, and forming a display layer 400 between the substrate 12 and the facing substrate 11.

[1] First, as shown in FIG. 4(a), the substrate 12 is prepared, and the first partition units 91 are formed on the second electrode 4 side of the substrate 12. The forming method of the first partition units 91 is not particularly limited, for example, it may be formed by forming a resin layer on the second electrode 4 and patterning the resin layer by etching or the like.

[2] Next, as shown in FIG. 4(b), a porous layer 6 is formed inside each region S. The formation of the porous layer 6 is not particularly limited, for example, it may be formed by preparing a coating liquid in which the fiber 61a configuring the porous layer 6 is dispersed in a solvent, coating the coating liquid inside each region S using a droplet ejection method, and performing drying thereon (volatilizing the solvent). Here, the coating method of the coating liquid is not limited to the droplet ejection method, and various types of printing method such as screen printing or gravure printing may be used. Further, the non-woven body 61 may also be laid in the region S.

[3] Next, as shown in FIG. 4(c), a dispersion liquid 100 corresponding to each region is filled in each region S. The filling method of the dispersion liquid 100 is not particularly limited; however, the use of the droplet ejection method is preferable. In this case, the dispersion liquid 100 is preferably filled inside each region S while moving the ejection nozzle in the X axis direction.

Since the dispersion liquid 100 filled in the region S1 is held in the porous layer 6, in this state, leakage of the dispersion liquid 100 from inside the regions S is effectively prevented. For this reason, for example, it is possible to suppress the generation of a problem in which the dispersion liquid 100 leaks from a certain region S into an adjacent region S during the bonding with the facing substrate 11 described above or the like and first particles A having different colors are mixed together, and to manufacture a display device 20 having superior display characteristics. In particular, when a water-repellent process is performed on the first partition units 91, the above effect becomes more pronounced. In addition, since the dispersion liquid 100 soaks into the porous layer 6, the generation of bubbles inside the dispersion liquid 100 can be effectively prevented. Therefore, it is possible to manufacture a display device 20 having superior display characteristics.

[4] Next, as shown in FIG. 4(d), by bonding the facing substrate 11 and forming a seal portion 5, the display layer 400 is formed, whereby a display device 20 is obtained. The bonding of the facing substrate 11 is performed by crimping the facing substrate 11 under an air atmosphere or under a reduced-pressure atmosphere. In addition, for example, when the facing substrate 11 is one which is wound into a roll shape, crimping may be performed by roll laminating along the X direction. By roll laminating along the X direction (extension direction of the first partition units 91), the first partition units 91 become a guide, and it is possible to prevent bending or the like of the facing substrate 11. In addition, even when bubbles are generated in the dispersion liquid 100, since the bubbles are discharged to the outside by the guiding first partition units 91, it is possible to more reliably remove the bubbles.

Here, the bonding temperature is not particularly limited; however, approximately room temperature or more to 120° C. or less is preferable. In this manner, it is possible to prevent softening or the like of the first partition units 91 or evaporation of the dispersion liquid 100.

According to the manufacturing method, as described above, since it is possible to prevent the mixing of first particles A having different colors and the generation of bubbles, it is possible to easily manufacture a display device 20 having superior display characteristics without causing a deterioration of the display characteristics.

### Second Embodiment

Next, a description will be given of the display device according to a second embodiment of the present invention.

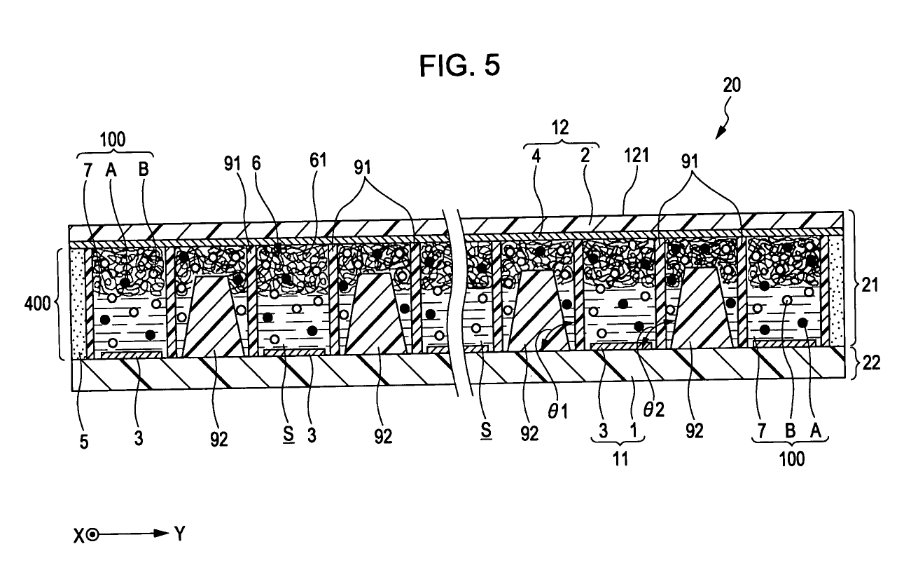

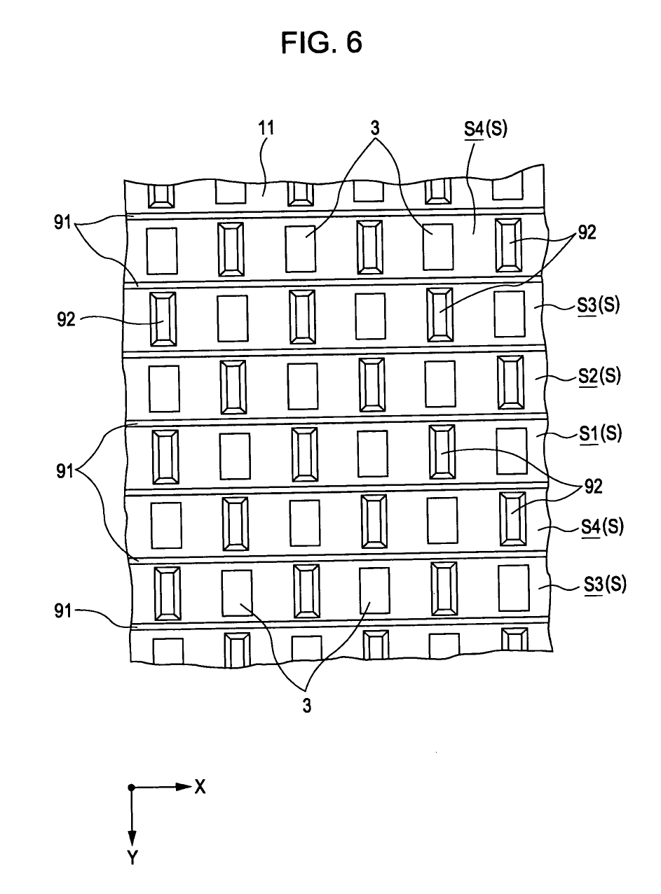

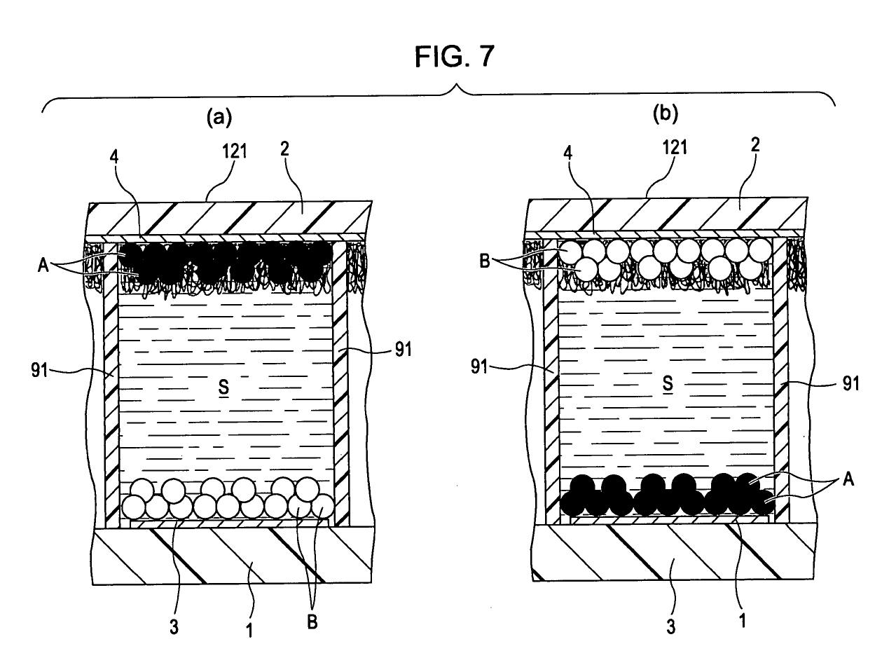

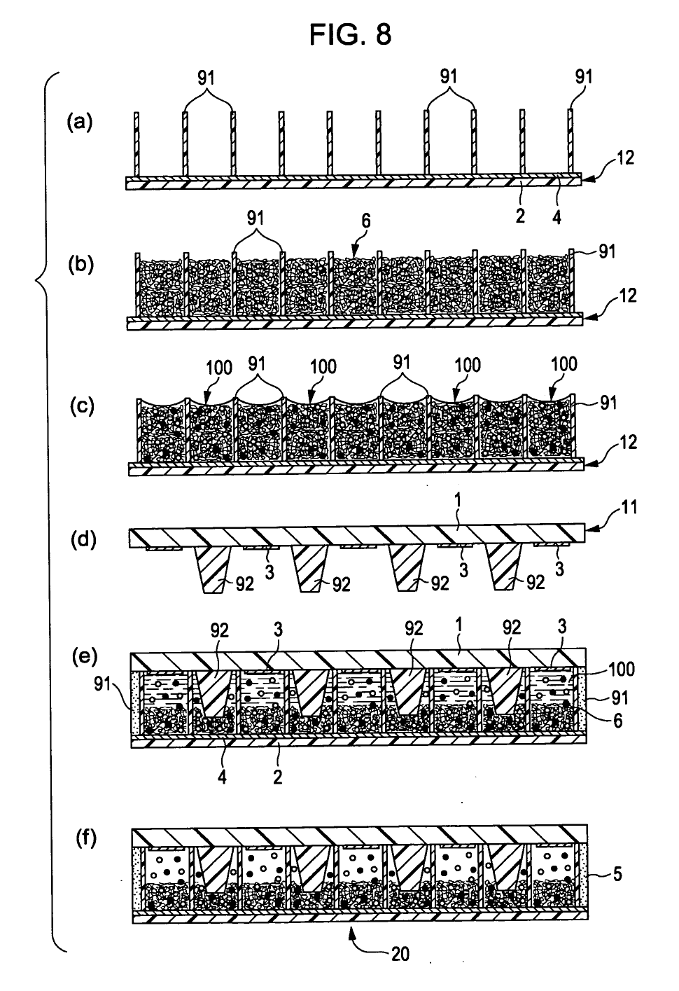

FIG. 5 is a cross-sectional view showing the display device according to a second embodiment of the present invention, FIG. 6 is a plan view (upper surface view) of the display device shown in FIG. 5, FIG. 7 is a cross-sectional view describing the driving of the display device shown in FIG. 5, and FIG. 8 is a cross-sectional view describing the method of manufacturing the display device shown in FIG. 5. In addition, in FIG. 6, for convenience of description, illustration of the substrate 12 and the porous layer 6 is omitted.

Below, a description will be given of the second embodiment focusing on the differences to the above-described embodiment and omitting any description of the similarities.

The display device according to a second embodiment of the present invention is the same as the display device of the first embodiment other than the arrangement of the first electrodes and the fact that second partition units are provided in the display layer. Here, where the configuration is the same as the first embodiment described above, the same reference numerals are used.

As shown in FIG. 5 and FIG. 6, the first electrode 3 is an individual electrode (pixel electrode connected to the TFT) divided into a zigzag shape in the X direction and the Y direction. In the display device 20, a region where one of the first electrodes 3 and the second electrode 4 overlap configures one pixel.

Further, the display layer 400 includes a plurality of first partition units 91, a plurality of second partition units 92 provided in each region S divided by the first partition units 91, a porous layer 6 provided inside each region S, and a dispersion liquid 100 filled inside each region S.

Inside the display layer 400, a plurality of first partition units 91 extending in the X direction are provided. The plurality of first partition units 91 are disposed in parallel spaced apart at equal intervals in the Y direction. According to the plurality of first partition units 91, the display layer 400 is divided in a liquid-sealed manner (so that movement of liquid from a predetermined region S to a neighboring region S is prevented) into a plurality of regions S lined up in the Y direction. In addition, each region S is formed so as to include a column of a plurality of first electrodes 3 (pixels) lined up in the X direction. In other words, each region S is formed so as to separate adjacent pixels in the Y direction and to share adjacent pixels in the X direction. By configuring the plurality of first partition units 91 in this manner, the aperture ratio of the display surface 121 is improved and it is possible to exhibit superior display characteristics.

In addition, each region S is formed so that the length (width) of the Y direction is constant along the X direction. In this manner, since each region S has a simple shape, it is possible to simplify the manufacturing of the display device 20. The width of each region S (the separation distance between adjacent first partition units 91) is not particularly limited; however, approximately 30 μm or more to 60 μm or less is preferable. In this manner, it is possible to fill a sufficient amount of the dispersion liquid 100 in each region S and to make the pixels smaller. Therefore, according to the display device 20, it is possible to display a fine and clear image using the display surface 121.

Each first partition unit 91 forms a straight line. In this manner, since not only does the configuration of the first partition units 91 become simple, but it is possible to continuously coat the dispersion liquid 100 having similar particles or a plurality of particles in a stripe shape using an ink jet method or various types of printing methods, it is possible to obtain an improvement in productivity. In addition, the width of each of the first partition units 91 (the length in the Y direction) is not particularly limited; however, approximately 1 μm or more to 5 μm or less is preferable. In this manner, it is possible to widen the aperture ratio of the display surface 121 while maintaining the mechanical strength of the first partition units 91. Therefore, it is possible to exhibit superior display characteristics and reliability.

In addition, it is preferable that the surfaces of the first partition units 91 be subjected to various water-repellent processes such as fluorocarbon plasma processing. In this manner, as described later, the manufacturing of the display device 20 becomes simple, and it is possible to obtain a display device 20 capable of exhibiting superior display characteristic and reliability.

The configuration material of the first partition units 91 is not particularly limited, for example, epoxy resins, phenol resins, urea resins, melamine resins, polyesters (unsaturated polyesters), polyimides, silicone resin, various kinds of thermoplastic or thermosetting resin such as urethane or the like may be exemplified, and it is possible to use a mix of one kind or two kinds or more among these.

Here, in this embodiment, the cross-sectional surface shape of each first partition unit 91 is rectangular (oblong); however, it is not limited thereto, for example, the width may have a tapered shape gradually reduced from the substrate 12 toward the facing substrate 11 side. The taper angle θ1 of this case (the angle made by the side surface of the first partition units 91 and the upper surface of the facing substrate 11 as shown in FIG. 5 in the plan view seen from the X direction) is not particularly limited; however, an angle of approximately 70° or more to 90° or less is preferable. In this manner, it is possible to prevent that the width of the substrate 12 of the first partition units 91 becomes excessively wide, or that the width of the facing substrate 11 opposite thereto becomes excessively narrow.

Above, a description has been given of the first partition units 91.

As shown in FIG. 5 and FIG. 6, inside each region S of the display layer 400, a plurality of second partition units 92 are provided spaced at intervals in the X direction. According to the second partition units 92, since it is possible to easily separate the dispersion liquid 100 continuously coated at high speed in stripe shapes between the first partition units 91 into pixel sections by the bonding, it is possible to improve productivity. In addition, it is possible to suppress biasing of the first and second particles A and B in the X direction, to prevent biasing of the first and second particles A and B inside the display layer 400, and to maintain a state where the first and second particles A and B are uniformly dispersed in the display layer 400. In addition, by providing the second partition units 92, as described above, the bonding precision of the facing substrate 11 (circuit substrate 22) is improved and it is possible to manufacture the display device 20 with higher precision.

The second partition units 92 are formed in a long shape extending in the Y direction, and arranged so as to be positioned between a pair of adjacent first electrodes 3 in the X direction in each region S. In other words, the second partition units 92 are arranged in a zigzag shape so as to correspond to the arrangement of the first electrodes 3. Since the second partition units 92 are arranged so as to avoid the electric field formed between the first electrode 3 and the second electrode 4 by setting such a shape and arrangement, it is possible to effectively prevent the obstruction of the migration of the first and second particles A and B using the second partition units 92.

Each second partition unit 92 is formed so as to protrude from the facing substrate 11 into the display layer 400 (region S) and an interval is formed with the substrate 12 (second electrode 4). In this manner, it is possible to fix the second partition units 92 inside the display layer 400 and the second partition units 92 do not stand out when seen from the display surface 121 side. In addition, since it is possible for the first and second particles A and B to enter into the interval between the second partition units 92 and the substrate 12, it is possible to prevent deterioration of the aperture ratio of the display surface 121 and to maintain superior display characteristics.

The size of the interval (separation distance) between each second partition unit 92 and substrate 12 is not particularly limited; however, approximately 1 μm or more to 5 μm or less is preferable. In this manner, the interval has a sufficient size (thickness) for the first and second particles A and B to enter. In addition to this, since it is possible to prevent excessive deformation of the substrate 12 by bringing the second partition units 92 into contact therewith, it is possible to increase the mechanical strength of the display device 20. In particular, as described above, it is possible to further increase the mechanical strength by arranging the second partition units 92 in a zigzag shape.

In addition, each of the second partition units 92 is formed with a tapered shape in which the length in the Y direction gradually decreases from the facing substrate 11 side toward the substrate 12 side. By forming the second partition units 92 with such a shape, as described above, it is possible to perform the bonding of the facing substrate 11 (circuit substrate 22) more easily and with higher precision. The taper angle θ2 (the angle made by the side surface of the second partition units 92 and the upper surface of the facing substrate 11 as shown in FIG. 5 in the plan view seen from the X direction) is preferably larger than the taper angle θ1, specifically, approximately 120° or more to 160° or less is preferable. In this manner, it is possible to exhibit the above-described effect more effectively. Further, since it is possible to largely preserve the area (projecting area) when seen from the X direction of the second partition units 92, and to increase the contact probability of the first and second particles A and B with the second partition units 92, it is possible to more effectively suppress the movement of the first and second particles A and B in the X direction.

In addition, the length in the Y direction of the base end of each of the second partition units 92 is not particularly limited; however, when the length in the Y direction of the regions S is set as A, approximately 0.7 A or more to 1 A or less is preferable, and approximately 0.9 A or more to 1 A or less is more preferable. By forming the second partition units 92 with such a shape, it is possible to perform the bonding of the facing substrate 11 with higher precision.

The configuration material of the second partition units 92 is not particularly limited; however, for example, the same material as the first partition units 91 described above may be exemplified.

Above, a description has been given of the second partition units 92.

As shown in FIG. 5, inside each region S of the display layer 400, a porous layer 6 is provided so as to be embedded in the intervals between the second partition units 92 and the substrate 12. The porous layer 6 has an effect of raising the permeability of the dispersion liquid 100, and improving the pattern coatability of the dispersion liquid 100 formed between the first partition units 91. In addition, the porous layer 6 has a function of regulating (suppressing) the movement according to the precipitation according to the weight of the particles A and B and the diffusion in the dispersion medium and performing holding in the vicinity of the surface of the first electrode 3 or the second electrode 4, by holding the first particles A and the second particles B in the dispersion liquid 100 in the interior or the surface thereof. On the other hand, in the porous layer 6, when an electric field acts between the first and second electrodes 3 and 4, it is possible for the first and second particles A and B to move between the electrodes according to the electric field. Furthermore, a structure may be adopted in which the porous layer 6 is only formed at the visible side of the second electrode 4, and the holding is only applied to the particles on the visible side. In this manner, it is possible to further increase the migration speed of the first and second particles A and B.

The porous layer 6 is configured by an aggregation of the fibers 61a. In this manner, a porous layer 6 which is excellent in the above function and which has a comparatively simple configuration is obtained. By using fibers 61a alone or mixing a small amount of binder resin with the fibers 61a, the porous layer 6 is configured by a non-woven body 61 formed without being interwoven. Since the fiber diameter and the inter-fiber distance of the non-woven body 61 may be set independently, it is possible to easily form a porous layer 6 capable of exhibiting the desired functions by configuring the porous layer 6 using the non-woven body 61. Here, since the configuration of the fibers 61a is the same as the first embodiment described above, a description thereof is omitted.

The average pore diameter of the non-woven body 61 is not particularly limited as long as it is a size in which it is possible for the first and second particles A and B to move in the non-woven body 61 when an electric field is applied; however, specifically, approximately 10 times or more to 10000 or less of the average particle diameter of the first particles A (second particles B) is preferable and approximately 20 times or more to 1000 times or less is more preferable. In this manner, it is possible to more effectively regulate the movement according to the weight of the first and second particles A and B. In addition, since it is possible to make the use amount of the fiber 61a used for forming the porous layer 6 comparatively small, when seen from the display surface 121, light transmittance loss due to the porous layer 6 is reduced and the visibility of the electrophoretic particles is improved.

The porosity (porosity in a state of being arranged in the display layer 400) of the porous layer 6 is preferably approximately 50% or more to 99% or less and preferably approximately 75% or more to 85% or less. In this manner, in the porous layer 6, the first and second particles A and B migrate smoothly during the voltage application. Further, it is possible to effectively regulate the movement according to the weight of the first and second particles A and B. In addition, since it is possible to make the use amount of the fiber 61a used for forming the porous layer 6 comparatively small, the porous layer 6 does not stand out when seen from the display surface 121.

The modulus of elasticity of the fiber 61a is not particularly limited; however, approximately 0.01 Mpa or more to 1000 MPa or less is preferable. In this manner, the porous layer 6 is appropriately deformed and, in particular, is useful in the case of a flexible display device 20.

Further, the porous layer 6 is preferably colored white. In this manner, in the white display state to be described later, it is possible to display a crisp white with higher reflectivity due to the synergistic effect of the second particles B. In addition, it is also preferable that the porous layer 6 be substantially colorless and transparent and have a different refractive index to the dispersion liquid 100. In this manner, since the light is diffused and reflected by the porous layer 6, similarly to the case of being colored white, it is possible to display a crisp white with higher reflectivity due to the synergistic effect of the second particles B in the white display state.

Such a porous layer 6 may be fixed to the substrate 12 by adhesion or the like or may not be fixed to the substrate 12. In addition, the porous layer 6 may be arranged in a natural state between the substrate 12 and the second partition units 92, or may be arranged in a state of being compressed in the thickness direction by being pinched by the substrate 12 and the second partition units 92.

Above, a detailed description has been given of the configuration of the display device 20 of the embodiment. In the display device 20, as a result of using the first partition units 91 extending in the X direction, it is possible to increase the aperture ratio of the display surface 121 and to exhibit a high display contrast.

Further, in the display device 20, according to the operation of the porous layer 6 and the second partition units 92 inside each region S, it is possible to regulate the movement in the X direction (movement due to their own weight) of the first and second particles A and B. To give a specific description, in the display surface 121 side of each region S, the porous layer 6 regulates the movement of the first and second particles A and B in the X direction by performing holding, and in other regions, the movement of the first and second particles A and B in the X direction is regulated by the first and second particles A and B colliding with the second partition units 92.

Therefore, In addition, it is possible to suppress biasing of the first and second particles A and B in the display layer 400 and to maintain a state where the first and second particles A and B are uniformly dispersed in the display layer 400 in the plan view of the display layer 400. As a result, it is possible to preserve approximately the same display characteristics (especially the reflectivity of the display color) in the entire area of the display layer 400 and to display crisp images with no unevenness over long periods on the display surface 121.

Specifically, for example, when the display device 20 is made to stand as a book, for instance, when the display surface 121 has a posture so as to be approximately parallel to the vertical direction, the first and second particles A and B are moved to the lower side of the vertical direction by their own weight. However, the movement due to their own weight is regulated by the porous layer 6 and the second partition units 92. Therefore, in the display device 20, it is possible to maintain a state where the first and second particles A and B are uniformly dispersed in each region S, and to display crisp images with no unevenness over long periods on the display surface 121.

In addition, in the portion (facing substrate 11 side of the display layer 400) where there is no porous layer 6, since it is possible to smoothly migrate the first and second particles A and B, the response speed is improved. The display device 20 is driven in the following manner, for example.

Here, below, a description will be given of a case where a voltage is applied to one predetermined third electrode.

—Color Display State of the First Particles—

When a voltage is applied between the first electrode 3 and the second electrode 4 so that the first electrode 3 has a negative potential and the second electrode 4 has a positive potential, the electric field generated by the application of the voltage acts on the first and second particles A and B in the display layer 400. Then, the first particles A migrate to the side of the second electrode 4 and are gathered at the second electrode 4, and the second particles B migrate to the side of the first electrode 3 and are gathered at the first electrode 3. In this manner, as shown in FIG. 7(a), the color of the first particles A is displayed on the display surface 121.

—Color Display State of the Second Particles—

When a voltage is applied between the first electrode 3 and the second electrode 4 so that the first electrode 3 has a positive potential and the second electrode 4 has a negative potential, the electric field generated by the application of the voltage acts on the first and second particles A and B in the display layer 400. Then, the first particles A migrate to the side of the first electrode 3 and are gathered at the first electrode 3, and the second particles B migrate to the side of the second electrode 4 and are gathered at the second electrode 4. In this manner, as shown in FIG. 7(b), the color of the second particles B is displayed on the display surface 121.

Next, the method of manufacturing the display device 20 will be described.

The method of manufacturing the display device 20 includes: forming a plurality of first partition units 91 spaced at intervals in the X direction on one surface of the substrate 12 and extending in the Y direction, and forming a plurality of divided regions S using adjacent pairs of the first partition units 91; filling a dispersion liquid 100 inside each region S; and bonding the facing substrate 11 having a plurality of second partition units 92 formed so as to protrude to the opposite side of the substrate 12 of the first partition units 91 while positioning the second partition units 92 on the substrate 12 side and allowing the second partition units 92 to intrude inside the regions S, and forming a display layer 400 between the substrate 12 and the facing substrate 11.

Below, a detailed description will be given of the manufacturing method.

[1] First, as shown in FIG. 8(a), the substrate 12 is prepared, and the first partition units 91 are formed on the second electrode 4 side of the substrate 12. The forming method of the first partition units 91 is not particularly limited, for example, it may be formed by forming a resin layer on the second electrode 4 and patterning the resin layer by etching or the like.

[2] Next, as shown in FIG. 8(b), a porous layer 6 is formed inside each region S. The formation of the porous layer 6 is not particularly limited, for example, it may be formed by preparing a coating liquid in which the fiber 61a configuring the porous layer 6 is dispersed in a solvent, coating the coating liquid inside each region S using a droplet ejection method, and performing drying thereon (volatilizing the solvent). Here, the coating method of the coating liquid is not limited to the droplet ejection method, and various types of printing method such as screen printing or gravure printing may be used. Further, the non-woven body 61 may also be laid in the region S.

[3] Next, as shown in FIG. 8(c), a dispersion liquid 100 corresponding to each region is filled in each region S. The filling method of the dispersion liquid 100 is not particularly limited; however, the use of the droplet ejection method is preferable. In this case, the dispersion liquid 100 is preferably filled inside each region S while moving the ejection nozzle in the X axis direction.

Since the dispersion liquid 100 filled in the region S1 is held in the porous layer 6, in this state, leakage of the dispersion liquid 100 from inside the regions S is effectively prevented. Therefore, for example, it is possible to suppress the generation of a problem in which the dispersion liquid 100 leaks from a certain region S into an adjacent region S during the bonding with the facing substrate 11 (circuit substrate 22) described above and first particles A having different colors are mixed together, and to manufacture a display device 20 having superior display characteristics. In particular, when a water-repellent process as described above is performed on the first partition units 91, the above effect becomes more pronounced. In addition, since the dispersion liquid 100 soaks into the porous layer 6, the generation of bubbles inside the dispersion liquid 100 can be effectively prevented. Therefore, it is possible to manufacture a display device 20 having superior display characteristics.

[4] Next, as shown in FIG. 8(d), a facing substrate 11 (circuit substrate 22) in which second partition units 92 are formed is prepared. For example, it is possible to form this member by forming a resin layer on a surface on which the first electrode 3 of the facing substrate 11 (circuit substrate 22) is formed and patterning the resin layer by etching or the like.

[5] Next, as shown in FIG. 8(e), the facing substrate 11 is bonded to the upper surface of the first partition units 91 while allowing the second partition units 92 to intrude in the regions S. In this manner, a display layer 400 having a plurality of regions S is formed between the substrate 12 and the facing substrate 12. In this case, the second partition units 92 come into contact with the first partition units 91 and are guided to slide into the regions S, whereby it is possible to perform position determination (in particular, position determination in the Y direction) of the facing substrate 11 with respect to the substrate 12 with high precision. That is, it is possible to use the second partition units 92 as a guide, and to increase the precision of the bonding position of the facing substrate 11.

In particular, when the taper angle θ2 of the second partition units 92 is the above-described angle, by improving the sliding of the second partition units 92 and the first partition units 91, the function as a guide of the second partition units 92 is improved and it is possible to more accurately and smoothly perform the bonding of the facing substrate 11. In addition, when the length in the Y direction of the base end of the second partition units 92 is in the above-described range, it is possible to more effectively suppress deviation of the Y direction of the facing substrate 11.

The bonding of the facing substrate 11 is performed by crimping the facing substrate 11 under an air atmosphere or under a reduced-pressure atmosphere. In addition, for example, when the facing substrate 11 is one which is wound into a roll shape, crimping may be performed by roll laminating along the X direction. By roll laminating along the X direction (extension direction of the first partition units 91), the first partition units 91 become a guide, and it is possible to prevent bending or the like of the facing substrate 11. In addition, even when bubbles are generated in the dispersion liquid 100, since the bubbles are discharged to the outside by the guiding first partition units 91, it is possible to more reliably remove the bubbles.

Here, the bonding temperature is not particularly limited; however, a temperature of approximately room temperature or more to 120° C. or less is preferable. In this manner, it is possible to prevent softening or the like of the first partition units 91 or evaporation of the dispersion liquid 100. Further, when the porous layer 6 is configured by a thermoplastic resin material, a bonding temperature of approximately 100° C. to 120° C. is preferable. In this manner, the porous layer 6 enters a softened state, and it is possible to make the porous layer 6 and the second partition units 92 adhere to each other. By adhering the second partition units 92 and the porous layer 6, the mechanical strength and reliability of the display device 20 are improved.

[6] Next, as shown in FIG. 8(f), by forming the seal portion 5 at the periphery of the display layer 400, a display device 20 is obtained.

According to the manufacturing method, as described above, since it is possible to prevent the mixing of first particles A having different colors and the generation of bubbles, it is possible to easily manufacture a display device 20 having superior display characteristics without causing a deterioration of the display characteristics. Further, it is possible to suppress positional deviation of the facing substrate 11 and to easily manufacture a display device 20 having superior reliability. In particular, when the facing substrate 11 has flexibility, the bonding position thereof tends to deviate due to the expansion of the facing substrate 11; however, if the second partition units 92 are present, it is possible to effectively prevent positional deviation.

### Third Embodiment

Next, a description will be given of the display device according to a third embodiment of the present invention.

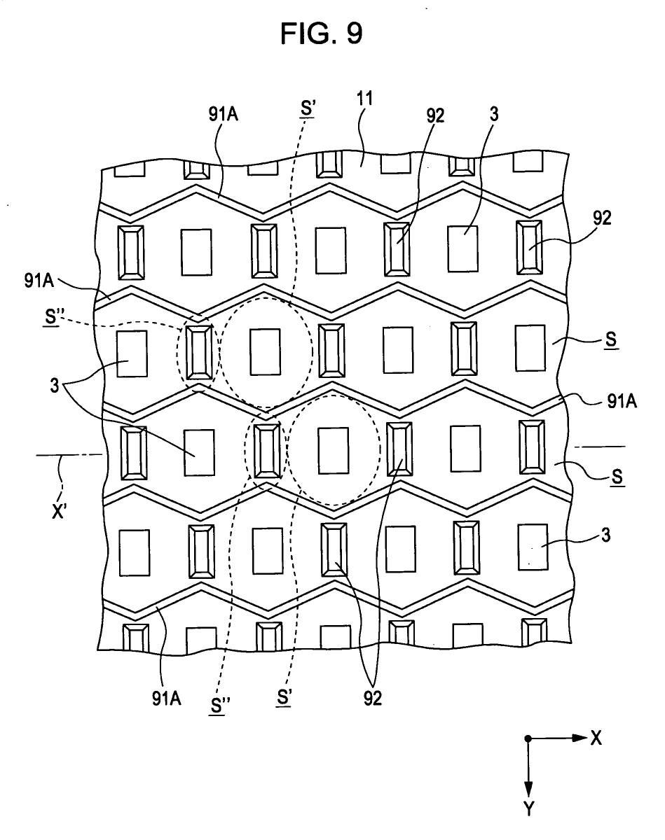

FIG. 9 is a plan view (upper surface view) showing a display device according to a third embodiment of the present invention. In addition, in FIG. 9, for convenience of description, illustration of the substrate 12 and the porous layer 6 is omitted.

Below, a description will be given of the third embodiment focusing on the differences to the above-described embodiments and omitting any description of the similarities.

The display device according to a third embodiment of the present invention is the same as the display device of the second embodiment other than the different configuration (shape) of the first partition units. Here, where the configuration is the same as the second embodiment described above, the same reference numerals are used.

As shown in FIG. 9, each first partition unit 91A extends in the X direction while reciprocating in the Y direction. That is, each first partition unit 91A meanders in the X direction. In addition, adjacent pairs of first partition units 91A are formed in axial symmetry with respect to the axis X′ positioned therebetween and extending in the X axis direction.

In this manner, each region S has a plurality of broad regions S′ provided spaced at intervals in the X direction, and a plurality of narrow regions S″ provided between the adjacent broad regions S′ and in which the length in the Y direction is shorter than the broad regions S′. Then, in each of the regions S, a first electrode 3 is positioned in each wide region S′, and second partition units 92 are positioned in each narrow region S″. According to such a configuration, since the movement of the first and second particles in the X direction is suppressed by the narrow regions S″, it is possible to more reliably regulate the movement of the first and second particles A and B in the X direction as a result of the synergistic effect of the porous layer 6 and the second partition units 92. In addition, since it is possible to shorten the length in the Y direction of the second partition units 92, the second partition units 92 are miniaturized, and the second partition units 92 become less noticeable.

### Fourth Embodiment

Next, a description will be given of the display device according to a fourth embodiment of the present invention.

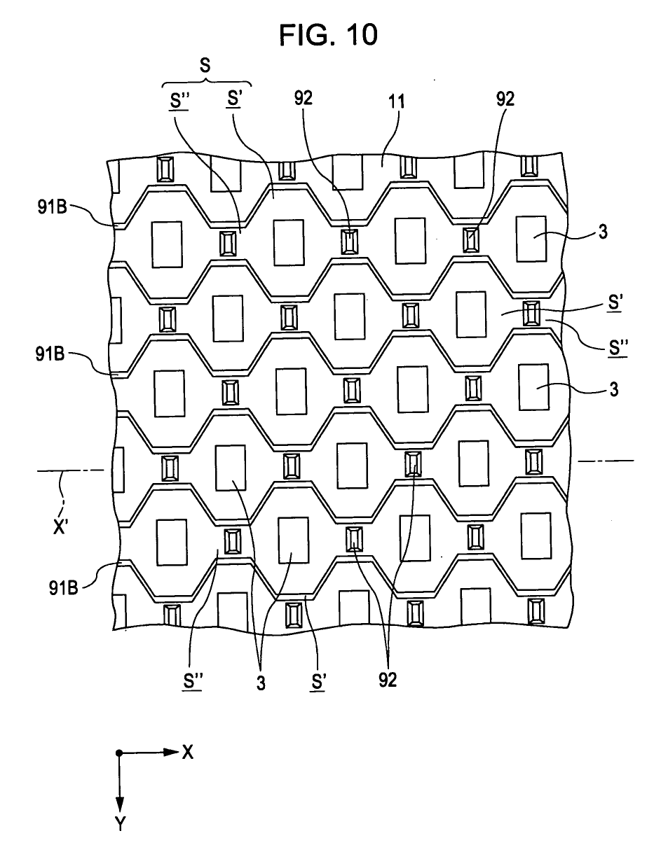

FIG. 10 is a plan view (upper surface view) showing a display device according to a fourth embodiment of the present invention. In addition, in FIG. 10, for convenience of description, illustration of the substrate 12 and the porous layer 6 is omitted.

Below, a description will be given of the fourth embodiment focusing on the differences to the above-described embodiments and omitting any description of the similarities.

The display device according to the fourth embodiment of the present invention is the same as the display device of the second embodiment other than the different configuration (shape) of the first partition units. Here, where the configuration is the same as the second embodiment described above, the same reference numerals are used.

In FIG. 10, each first partition unit 91B extends in the X direction while reciprocating in the Y direction. That is, each first partition unit 91B meanders in the X direction. In addition, adjacent pairs of first partition units 91B are formed in axial symmetry with respect to the axis X′ positioned therebetween and extending in the X axis direction.

In this manner, each region S has a plurality of broad regions S′ provided spaced at intervals in the X direction, and a plurality of narrow regions S″ provided between the adjacent broad regions S′ and in which the length in the Y direction is shorter than the broad regions S′. Then, in each of the regions S, a first electrode 3 is positioned in each wide region S′, and second partition units 92 are positioned in each narrow region S″. According to such a configuration, since the movement of the first and second particles in the X direction is suppressed by the narrow regions S″, it is possible to more reliably regulate the movement of the first and second particles A and B in the X direction as a result of the synergistic effect of the porous layer 6 and the second partition units 92. In addition, since it is possible to shorten the length in the Y direction of the second partition units 92, the second partition units 92 are miniaturized, and the second partition units 92 become less noticeable.

In addition, compared with the second embodiment described above, since the length of the X direction of the narrow regions S″ is long, when the facing substrate 11 is bonded to the first partition units 91B, even if the facing substrate 11 is slightly deviated in the X direction with respect to the first partition units 91, it is easy to position the second partition units 92 inside the narrow regions S″. In other words, even if the facing substrate 11 is deviated slightly, since a deterioration of the display characteristics is not caused, it is possible to more easily and reliably manufacture a display device 20 capable of exhibiting desired display characteristics. In particular, when the facing substrate 11 is configured with a flexible member, the facing substrate 11 is easily stretched, and prone to positional deviation. Therefore, this configuration is particularly effective when manufacturing the flexible display device 20.

### Fifth Embodiment

Next, a description will be given of the display device according to a fifth embodiment of the present invention.

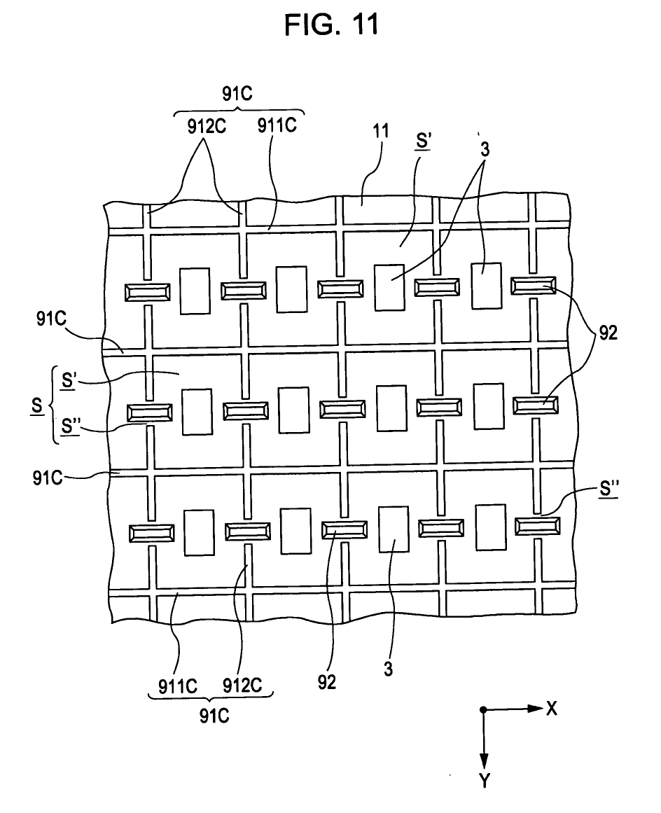

FIG. 11 is a plan view (upper surface view) showing a display device according to a fifth embodiment of the present invention. In addition, in FIG. 11, for convenience of description, illustration of the substrate 12 and the porous layer 6 is omitted.

Below, a description will be given of the fifth embodiment focusing on the differences to the above-described embodiments and omitting any description of the similarities.

The display device according to the fifth embodiment of the present invention is the same as the display device of the second embodiment other than the different configuration (shape) of the first partition units. Here, where the configuration is the same as the second embodiment described above, the same reference numerals are used.

As shown in FIG. 11, each first partition unit 91C is configured by a base 911C extending in the X direction, and a plurality of branch portions 912C provided spaced at intervals in the X direction and extending in the Y direction so as to intersect the base 911C. In addition, the branch portions 912C of adjacent first partition units 91C are formed so as to be spaced with gaps in the Y direction and to face each other.

In this manner, each region S has a plurality of broad regions S′ provided spaced at intervals in the X direction, and a plurality of narrow regions S″ (regions between a pair of branch portions 912C arranged facing the Y direction) provided between the adjacent broad regions S′ and in which the length in the Y direction is shorter than the broad regions S′. Then, in each of the regions S, a first electrode 3 is positioned in each wide region S′, and second partition units 92 are positioned in each narrow region S″. In addition, the second partition units 92 are provided extending in the X direction, and both ends thereof front onto the wide regions S′. According to such a configuration, due to the synergistic effect of the porous layer 6 and the second partition units 92, it is possible to more reliably regulate the movement of the first and second particles A and B in the X direction.

In addition, since the second partition units 92 extend in the X direction, similarly to the above-described third embodiment, when the facing substrate 11 is bonded to the first partition units 91C, even if the facing substrate 11 is slightly deviated in the X direction, it is easy to position the second partition units 92 inside the narrow regions S″. In other words, even if the facing substrate 11 is deviated slightly, since a deterioration of the display characteristics is not caused, it is possible to more easily and reliably manufacture a display device 20 capable of exhibiting desired display characteristics.

### Sixth Embodiment

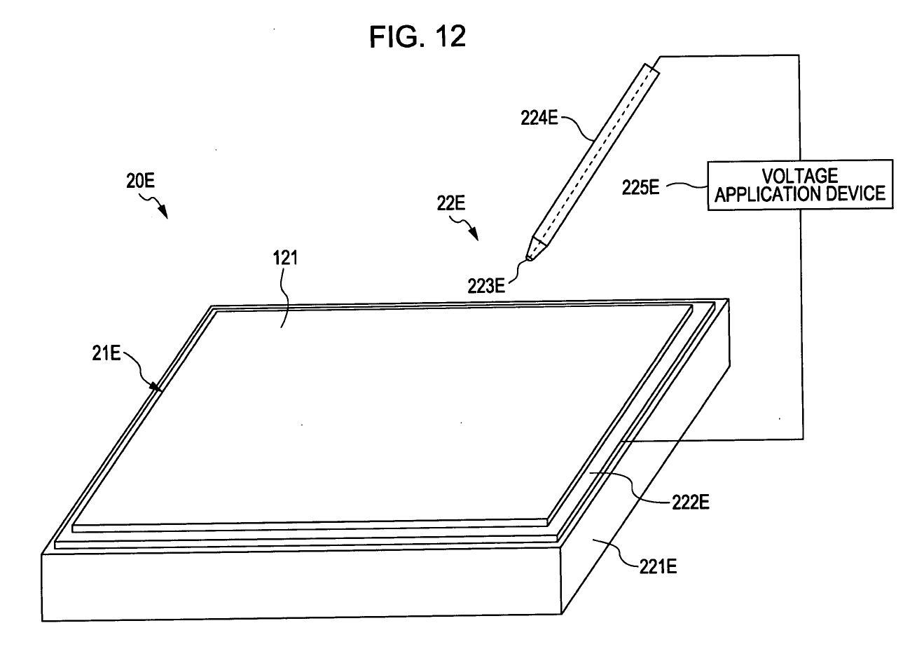

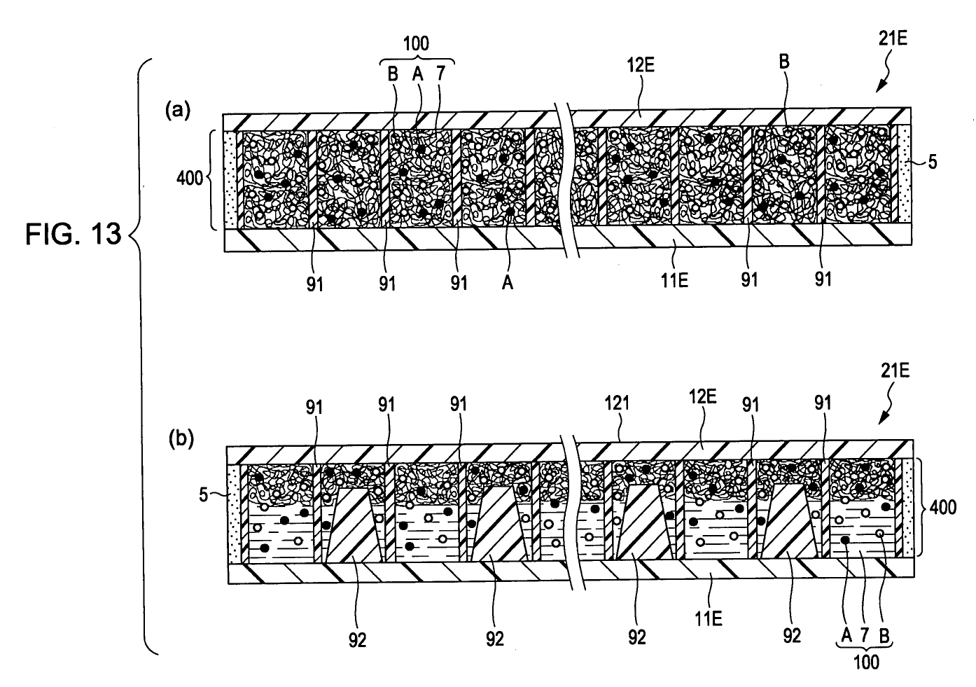

FIG. 12 is a schematic perspective view showing a display device according to a sixth embodiment of the present invention and FIG. 13 is a cross-sectional views of the display sheet shown in FIG. 12.

Below, a description will be given of the sixth embodiment focusing on the differences to the above-described embodiments and omitting any description of the similarities.

The display device according to the sixth embodiment of the present invention is the same as the display device of the first embodiment other than the fact that the display sheet is configured as a separate body.

As shown in FIG. 12, the display device 20E of the embodiment includes a display sheet 21E and a writing device 22E.

As shown in FIG. 13(a), the display sheet 21E includes: a substrate (first substrate) 12E, a substrate (second substrate) 11E arranged facing the substrate 12E, a display layer 400 provided between the substrates 12E and 11E, a seal portion 5 sealing the display layer 400, first partition units 91 and a porous layer 6 provided inside the display layer 400, and a dispersion liquid 100 filled inside the display layer 400. Since the substrates 12E and 11E respectively have the same configuration as the base 2 of the substrate 12 of the first embodiment described above, a description thereof is omitted. In addition, the configuration of the display layer 400 is the same as that of the display device of the first embodiment described above. That is, the display layer 400 shown in FIG. 13(a) includes a plurality of first partition units 91, a porous layer 6 provided inside each region S divided by the plurality of first partition units 91, and a dispersion liquid 100 filled inside each region S.

In addition, as shown in FIG. 13(b), in the display sheet 21E, the display sheet 400 may have the same configuration as the display device of the second embodiment described above. That is, the display layer 400 shown in FIG. 13(b) includes a plurality of first partition units 91, a plurality of second partition units 92 provided in each region S divided by the first partition units 91, a porous layer 6 provided inside each region S, and a dispersion liquid 100 filled inside each region S.

The writing device 22E is a device used when writing a desired image (a pattern, a color, characters, a picture, a combination of these, or the like) onto the display sheet 21E. As shown in FIG. 12, the writing device 22E includes a base 221E, a sheet-shaped common electrode 222E provided on the base 221E, a writing pen (input tool) 224E in which a portion electrode 223E is provided at the tip, and a voltage application device 225E which applies a voltage between the common electrode 222E and the portion electrode 223E.

The display device 20E is used in the following manner, for example.

First, the display sheet 21E in which the entirety of the display surface 121 is in a white display state is mounted on the common electrode 222E of the writing device 22E with the display surface 121 set to the upper side. Next, a voltage for making the portion electrode 223E side a low potential is applied between the common electrode 222E and the portion electrode 223E by the voltage application device 225E. In this state, by maintaining the contact of the writing pen 224E with the display surface 121 and moving in a desired path, migration of the particles in the region corresponding to the path is generated and the display color changes from white to black.

According to the display device 20E, it is possible to draw desired characters or the like on the display surface 121 of the display sheet 21E with the same feeling as drawing characters or the like with a lead pencil on paper. Therefore, the operability of the display device 20E (operation feeling) is improved.

The display device 20 described above can be respectively incorporated into various types of electronic apparatuses. As the electronic apparatus according to an embodiment of the present invention provided with the electrophoretic display device, for example, electronic paper, e-books, televisions, view finder-type or direct-view monitor-type video tape recorders, car navigation systems, pagers, electronic organizers, calculators, electronic newspapers, word processors, personal computers, workstations, video phones, POS terminals, electronic apparatuses provided with touch panels, and the like may be exemplified.

An example of electronic paper will be specifically described from among these electronic apparatuses.

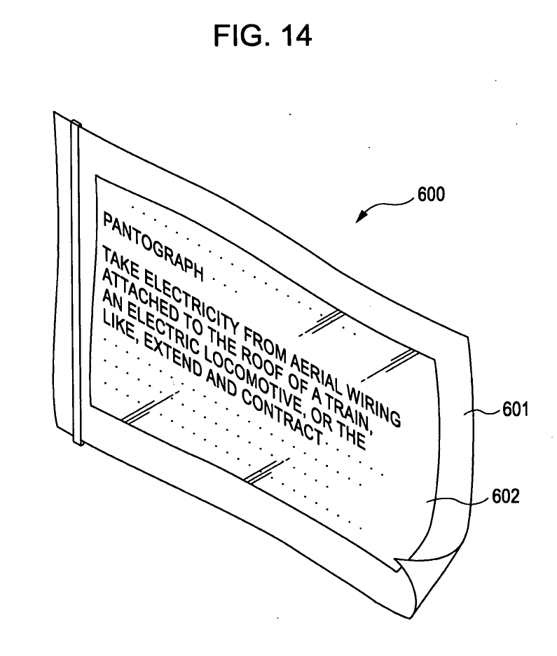

FIG. 14 is a perspective view showing a case where the electronic apparatus according to an embodiment of the present invention is applied to electronic paper.

The electronic paper 600 shown in FIG. 14 is provided with a main body 601 configured by a rewritable sheet having the same texture and flexibility as paper, and a display unit 602. In the electronic paper 600, the display unit 602 is configured by the display device 20 as described above.

Next, a description will be given of a case where the electronic apparatus according to an embodiment of the present invention is applied to a display.

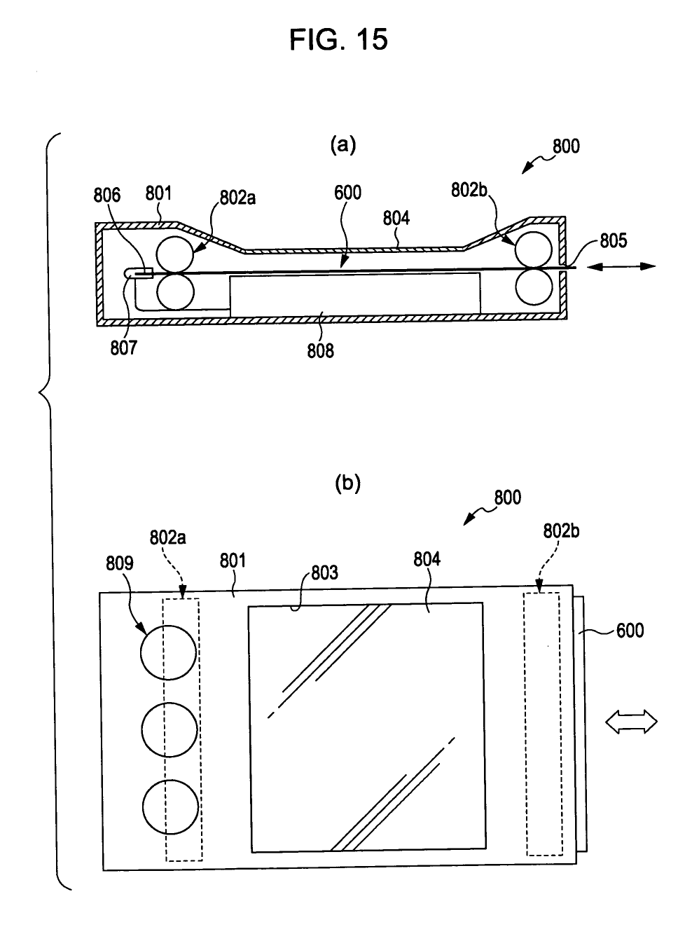

FIG. 15 is a diagram showing a case where the electronic apparatus according to an embodiment of the present invention is applied to a display. Here, FIG. 15(a) is a cross-sectional view, and FIG. 15(b) is a plan view.

The display (display device) 800 shown in FIG. 15 is provided with a main body unit 801, and electronic paper 600 provided so as to be freely detachable with respect to the main body unit 801. In addition, the electronic paper 600 has the configuration described above, that is, the same configuration as shown in FIG. 14.

The main body unit 801 has an insertion slot 805 allowing insertion of the electronic paper 600 formed in the side thereof (in FIG. 15(a), the right side), and is also provided with two sets of transport roller pairs 802a and 802b in the interior thereof. When the electronic paper 600 is inserted inside the main body unit 801 through the insertion slot 805, the electronic paper 600 is placed in the main body unit 801 in a state of being pinched by the transport roller pairs 802a and 802b.

In addition, at the display surface side of the main body unit 801 (in FIG. 15(b), the front side of the paper surface), a rectangular hole portion 803 is formed and a transparent glass plate 804 is fitted into the hole portion 803. In this manner, it is possible to view the electronic paper 600 in a state of being placed in the main body unit 801 from outside the main body unit 801. In other words, in the display 800, the electronic paper 600 in a state of being placed in the main body unit 801 is viewed in the transparent glass plate 804 and thereby configures a display surface.

In addition, at the insertion direction tip portion of the electronic paper 600 (in FIG. 15(a), the left side), a terminal unit 806 is provided, and, in the interior of the main body unit 801, a socket 807, to which the terminal unit 806 is connected in a state in which the electronic paper 600 is placed in the main body unit 801, is provided. In the socket 807, a controller 808 and an operation unit 809 are electrically connected.

In the display 800, the electronic paper 600 is placed to be freely detachable in the main body unit 801, and may be carried and used in a state of being removed from the main body unit 801. In this manner, the convenience is improved.

Above, a description has been given of the display sheet, the method of manufacturing the display sheet, the display device and the electronic apparatus according to an embodiment of the present invention based on the embodiments of the drawings; however, the present invention is not limited thereto and the configuration of each part may be changed to an arbitrary configuration having the same function. In addition, in the present invention, any other arbitrary configurational parts may be added. Further, each of the embodiments may be suitably combined.

The entire disclosure of Japanese Patent Application No.: 2011-093230, filed Apr. 19, 2011 and 2011-093231, filed Apr. 19, 2011 are expressly incorporated by reference herein.

1. A display sheet comprising:
a first substrate provided at a display surface side;
a second substrate arranged to face the first substrate; and
a display layer provided between the first substrate and the second substrate,
wherein the display layer includes, in a plan view of the display layer, a plurality of first partition units dividing the display layer into a plurality of regions in a first direction and extending in a second direction intersecting the first direction, a porous layer provided inside each of the plurality of regions, and a dispersion liquid filled inside each of the plurality of regions in which at least one type of positively or negatively charged first particle is dispersed with a dispersion medium.

2. The display sheet according to claim 1,
wherein the display layer includes a plurality of pixels which are set in plural along the first direction and set in plural along the second direction, and
each of the plurality of regions is formed so as to separate adjacent pixels in the first direction and include adjacent pixels in the second direction.

3. The display sheet according to claim 1,
wherein the porous layer regulates movement using precipitation and diffusion of the first particles.

4. The display sheet according to claim 1,
wherein the porous layer is an aggregation of fibers or an aggregation of particles.

5. The display sheet according to claim 1,
wherein each of the plurality of regions has a length in the first direction which is constant along the second direction.

6. The display sheet according to claim 5, further comprising a plurality of second partition units which are provided spaced at intervals in the second direction, protrude from the second substrate side, and are spaced apart from the first substrate in a thickness direction of the display layer.

7. The display sheet according to claim 1,
wherein each of the plurality of regions has a plurality of broad regions provided spaced at intervals in the second direction, and a plurality of narrow regions provided between the adjacent broad regions in the second direction and of which the length of the first direction is shorter than that of the broad regions.

8. The display sheet according to claim 7, further comprising a plurality of second partition units which are provided inside each of the plurality of narrow regions, protrude from the second substrate side, and are spaced apart from the first substrate in the thickness direction of the display layer.

9. The display sheet according to claim 6,
wherein, in each of the plurality of second partition units, the length of the first direction gradually decreases toward the first substrate from the second substrate side.

10. The display sheet according to claim 9,
wherein the porous layer is positioned between respective tips of the plurality of second partition units and the first substrate.

11. The display sheet according to claim 1,
wherein the first particles included in the dispersion liquid filled inside the adjacent regions have mutually different colors.

12. The display sheet according to claim 11, further comprising:
a first region;
a second region; and
a third region, which are arranged to be lined up in the first direction in the plurality of regions,
wherein, among the first particles included in the dispersion liquid filled inside the first region and the first particles included in the dispersion liquid filled inside the second region, a color of one is magenta and a color of the other is cyan, and a color of the first particles included in the dispersion liquid filled inside the third region is yellow.

13. The display sheet according to claim 12,
wherein the plurality of regions further include a fourth region arranged next to the third region, and the color of the first particles included in the dispersion liquid filled inside the fourth region is black.

14. The display sheet according to claim 1,
wherein the dispersion liquid further includes second white particles charged with the opposite polarity to the first particles.

15. A display sheet comprising:
a first substrate provided at a display surface side;
a second substrate arranged to face the first substrate; and
a display layer provided between the first substrate and the second substrate,
wherein the display layer includes, in a plan view of the display layer, a plurality of first partition units dividing the display layer into a plurality of regions in a first direction and extending in a second direction intersecting the first direction,
a plurality of second partition units which are arranged inside each of the plurality of regions to be spaced at intervals in the second direction, protrude from the second substrate side, and are spaced apart from the first substrate in the thickness direction of the display layer, and
a dispersion liquid filled inside each of the plurality of regions in which at least one type of positively or negatively charged first particle is dispersed with a dispersion medium.

16. A method of manufacturing a display sheet, comprising:
forming a plurality of first partition units spaced at intervals in a first direction on one surface of a first substrate and extending in a second direction intersecting the first direction, and forming a plurality of divided regions using an adjacent pair of the first partition units;
providing a porous layer inside each of the plurality of regions;
filling a dispersion liquid in which at least one type of positively or negatively charged first particle is dispersed with a dispersion medium inside each of the plurality of regions and holding the dispersion liquid in the porous layer; and
bonding the first substrate of the first partition units and the second substrate on the opposite side, and forming a display layer between the first substrate and the second substrate.

17. A display device comprising the display sheet according to claim 1.

18. A display device comprising the display sheet according to claim 15.

19. An electronic apparatus comprising the display device according to claim 17.

20. An electronic apparatus comprising the display device according to claim 18.
